(19) United States
(12) Patent Application Publication
(10) Pub. No.: US 2007/0034465 A1
(43) Pub. Date: Feb. 15, 2007

(54) Flexible bushing assembly for spring brake push rod center seal

(76) Inventors: Larry Thompson, Fresno, CA (US); Kevin Carlson, Fresno, CA (US); Matthew Messer, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/202,920

(22) Filed: Aug. 12, 2005

(51) Int. Cl. F16F 9/36

(52) U.S. Cl. 188/322.16; 188/322.17

(57) ABSTRACT

An improved bushing assembly for the center seal used with an adapter base separating pressure chambers in a spring brake actuator to allow a push rod to pass through an aperture therein without loss of pressurized fluid between the pressure chambers. The improved bushing assembly has a flexing component that allows for non-linear or flexing motion of the push rod, a sealing component for sealably engaging the push rod and a locking component for securing the bushing assembly inside the aperture. The improved bushing prevents damage to the sealing member and aperture from the non-linear push rod motion. The flexing component comprises a bushing member having an inner wall and outer wall that form a channel therebetween. The outer wall has engagement tabs to lockingly engage a groove in the aperture to secure the bushing assembly therein. A spring brake adapter is provided that utilizes the improved bushing assembly.

### CROSS-REFERENCE TO RELATED APPLICATIONS

None.

### BACKGROUND OF THE INVENTION

A. Field of the Invention

The field of the present invention relates generally to vehicle braking systems that are operated by air or other fluids. More particularly, the present invention relates to spring brake systems that utilize a spring to drive a rod through an aperture in a wall of pressurized chamber to actuate the brakes and apply a braking force. Even more particularly, the present invention relates to such spring brake systems having a sealing assembly that is configured to allow non-linear or flexing movement of the rod through the aperture.

B. Background

Most large commercial vehicles, such as heavy trucks and the like, utilize a hydraulic spring-operated braking system having a brake actuator that comprises a sealed pressure chamber for the compressed air or other hydraulic fluid used in the system and a powerful main compression spring disposed in a non-pressurized chamber as the actuator mechanism to provide the desired braking force. In normal driving or non-braking conditions, the pressure in the pressure chamber exceeds the compression force provided by main spring to prevent the brake actuator from actuating the brakes. As is well known, the typical commercial vehicle braking system is configured such that when the pressure in the pressure chamber is reduced below the level of force provided by the main spring, the main spring will drive a rod member, typically referred to as a push or actuator rod, through an aperture in the pressure chamber housing to operate the vehicle's brakes and stop the vehicle. The primary advantage of such a system is that if the vehicle's hydraulic system inadvertently loses its pressurized air, hydraulic oil or other fluid, the vehicle will be automatically placed in a braking condition instead of the situation where the brakes will not operate when the driver desires to slow or stop the vehicle. Naturally, for larger vehicles such as most commercial trucks and the like, the loss of hydraulic fluid leading to the inability to slow or stop the vehicle could lead to disastrous consequences for the driver, vehicle and other nearby drivers and their vehicles. The typical heavy truck and commercial vehicle also use this pressure released, brake on principle as the parking brake system for locking the vehicle's brakes in the braked condition when the vehicle is intended to remain still.

A common type of actuating mechanism utilized in heavy truck and commercial vehicle hydraulic spring brake systems comprises a multiple chamber actuator that is divided into a parking brake section having a non-pressurized spring chamber and a pressurized parking brake chamber, and a service brake section having an pressurizable upper service chamber and a non-pressurized lower service chamber. Typically, a one or two piece adapter base is utilized to separate the actuator into the two sections. The upper side of the adapter base is used in conjunction with a spring housing to form the parking brake section and the lower side of the adapter base is used in conjunction with a service housing to form the service brake section. A flexible parking chamber diaphragm extending between the adapter base and the spring housing divides the parking brake section into the non-pressurized spring chamber and the pressurized brake chamber. A flexible service chamber diaphragm extending between the adapter base and the service chamber forms the pressurizable upper service chamber and the non-pressurized lower service chamber. The main compression spring is disposed in the non-pressurized spring chamber between an end wall of the spring housing and a moveable spring pressure plate that abuts the parking chamber diaphragm. A push rod and parking return spring are disposed in the pressurized parking brake chamber. The non-pressurized service chamber encloses an actuator rod plate, which is in abutting relationship with the service chamber diaphragm, at the end of an actuator rod and a service return spring disposed between the service housing and the actuator rod plate. A portion of the actuator rod extends outside of the service housing and is attached to a clevis or other guide member that couples to the vehicle's brake mechanism. The push rod slidably extends through a center seal in an aperture in the adapter base to push against the service chamber diaphragm and actuator rod plate.

In the normal non-braking driving condition, the pressure inside the pressurized parking brake chamber exceeds the compression force of the main spring and, in the service brake section, the service return spring biases the actuator rod plate against the flexible service chamber diaphragm and the service chamber diaphragm toward the lower side of the adapter base. When the driver depresses the brake pedal, pressurized air or other fluid is directed into the upper service chamber, causing it to expand and force the service chamber diaphragm against the actuator rod plate to drive the actuator rod away from the brake actuator and cause the clevis to operatively engage the vehicle's braking system. When the driver stops the vehicle and sets the parking brake, air is released from the pressurized parking brake chamber so the force of the main compression spring exceeds the pressure in the parking brake chamber, causing the main spring to bias the spring pressure plate and the parking chamber diaphragm against the push rod disposed in the parking brake chamber. The push rod sealably moves through the center seal in the adapter base aperture to mechanically drive the service chamber diaphragm against the actuator rod plate, which in turn then drives the actuator rod away from the brake actuator to cause the clevis to operatively engage the vehicle's braking system. If the braking system inadvertently loses pressure, through a leak in a pressure line or other loss of hydraulic pressure, then the brake actuator will automatically operate in the manner described above for setting the parking brake (i.e., the push rod will drive the service chamber diaphragm against the adapter rod plate to drive the actuator rod outwardly of the brake actuator).

For the heavy truck or commercial vehicle brake systems described above, as well as other similarly configured braking systems, a very important component of the effectiveness of the braking system is the ability to seal and guide the movement of the push rod through the adapter base center seal. As set forth above, the push rod moves downward into the upper service chamber through the adapter base when the pressure in the pressurized parking brake chamber becomes lower than the force exerted by the main spring and then moves upward towards the non-pressurized spring chamber when the pressure inside the parking brake chamber is restored. In order for this system to work, it is necessary to provide a center sealing mechanism that maintains a seal against the push rod as it moves through the adapter base. To prevent undesirable wear against the push rod and/or the adapter base aperture, it is also important to guide the movement of the push rod through the adapter base. Although all main springs have some amount of side loading, causing generally non-linear push rod movement, the main spring can, over time, become crooked or otherwise provide excessive side loading to the push rod. The excessive side loading can be due to poor assembly, resulting in the main spring being somewhat off-center and causing the push rod to move through the adapter base aperture center seal in a somewhat non-linear or flexing manner. Without the piston/cylinder type of cooperative arrangement found in piston brakes that helps guide the piston rod, the flexing of the push rod can cause it to rub against the adapter base, typically made out of aluminum or other generally “softer” metals, causing wear that results in the inability to seal the adapter base aperture between the pressurized parking brake chamber and the upper service chamber. As is well understood by those skilled in the art, this type of leak results in an inoperable braking system and, therefore, vehicle.

A common method of providing the necessary sealing between the push rod and the adapter base is to provide a center seal comprising one or more grooves on the inside of the adapter base aperture that each have an elastomeric sealing member disposed therein. Unfortunately, this type of sealing assembly does not provide much guiding benefits for the push rod travel. As a result, the push rod tends to rub against the adapter base aperture and lead to a failed brake system. Various prior art devices have utilized metallic or plastic bushings disposed in the adapter base aperture as a means to prevent the push rod from wearing against the adapter base. Unfortunately, as with the adapter base itself, the non-linear or flexing movement of the push rod can cause excessive wear on the bushing and result in premature failure of the braking system. Although the use of bushings of this type would seem to be able to improve the longevity of the center seal between the parking brake chamber and the service chamber, the inability of these bushings to effectively compensate for the non-linear or flexing movement of the push rod results in little or no improvement from their use. An improved bushing assembly for double diaphragm spring brake actuators, set forth in U.S. Pat. No. 5,829,339 to Smith, utilizes a tubular sleeve that is affixed to the adapter base, a cylindrical bushing received in the sleeve and one or more sealing rings mounted in grooves disposed in the bushing. A mounting sealing ring is disposed between the bushing and a lip formed between the interior of the sleeve and the adapter base. Although the bushing is described as being made out of an injection moldable resin and being elastically deformable, it is nevertheless a solid, continuous member across the thickness of the bushing that is fixed in place and, as such, is subject to the same type of wear problems experienced by other prior art devices. Being solid and continuous across its width, the bushing will not sufficiently flex in response to non-linear or flexing movement of the push rod through the adapter base aperture. As a result, it will not achieve the full benefits desired for a bushing assembly configured for use with a spring brake push rod center seal.

What is needed, therefore, is an improved bushing assembly for the center seal component of a spring brake actuator that effectively seals the area between chambers on either side of the adapter base and which is configured to allow for non-linear or flexing movement of the push rod as it travels through the adapter base center seal. It is therefore desirable to provide a flexible bushing assembly for the center seal component of an adapter base utilized in spring brake actuators that is configured to sealably permit the push rod to move therethrough and allow for non-linear or flexing movement of the push rod. The preferred bushing assembly will be configured to reduce the likelihood of excessive wear on the center seal component and the aperture of the adapter base so as to better maintain the seal between the pressurized parking brake chamber and the non-pressurized upper service chamber and increase the longevity of the brake actuator effectiveness.

### SUMMARY OF THE INVENTION

The flexible bushing assembly for spring brake push rod center seal of the present invention provides the benefits and solves the problems identified above. That is to say, the present invention discloses a bushing assembly that substantially improves the ability of a spring brake push rod center seal to maintain its sealing ability with non-linear and flexing movement of the push rod through the aperture of the adapter base separating a pressurized chamber, such as a parking brake chamber, from a non-pressurized chamber, such as the upper service chamber, of a spring brake actuator. The flexible bushing assembly overcomes the limitations and drawbacks of existing center seal components for spring brake push actuators used in spring brake systems by allowing for the non-linear or flexing movement that is typical of a push rod as it moves through the adapter base aperture in response to the release of pressure from or the application of pressure to the pressurized parking brake chamber. Specifically, the flexible bushing assembly of the present invention comprises a bushing member having a non-continuous width that sealably allows for flexible movement of the push rod through the adapter base commonly utilized in spring brake actuator systems. As such, the flexible bushing assembly of the present invention will substantially eliminate metal to metal contact between the push rod and the adapter base and, as a result prevent the undesirable wear that leads to leaks and brake system failures. The present flexible bushing assembly allows the push rod to pivot in the center seal and find the path therethrough that is best for it to take in light of the off-center movement of the main compression spring, which will substantially reduce the effect of the side forces that are known to cause wear on the center seal and, therefore, increase the life of the center seal. As such, the flexible bushing assembly of the present invention will reduce the maintenance costs for vehicles having spring brake systems and increase the amount of time the vehicle is available for use on the road, where it can be an economic advantage for the owner/operator of the vehicle.

The flexible bushing assembly of the present invention is configured for use with a spring brake actuator having an adapter base used to separate a first pressure chamber, such as the parking brake chamber, from a second pressure chamber, such as the upper service chamber, and allow a push rod to pass therethrough so as to actuate a vehicle's brakes. In one general aspect of the present invention, the flexible bushing assembly includes a generally- cylindrical first bushing member, a generally cylindrical second bushing member and a sealing member disposed therebetween and is configured for the push rod to slidably pass therethrough. In one embodiment, the first bushing member is partially disposed in a narrowed aperture section of the adapter base aperture and in abutting relationship with a lip extension formed by the narrowed aperture section. In the preferred embodiment, the sealing member is an 0-ring. In alternative embodiments, the sealing member is a quad-ring (X-ring) or a specially configured sealing member. The sealing member is positioned on top of the first bushing member and configured to sealingly engage the push rod as it passes through the aperture during use of the brake adapter without allowing pressurized fluid to pass between the two chambers. In a preferred embodiment, the second bushing member has one or more locking elements, which in the preferred embodiment comprises a plurality of engagement tabs, configured to lockingly engage a groove placed in the wall of the adapter base aperture to secure it and the other components of the bushing assembly in the aperture. Also in a preferred embodiment, the second bushing member is configured to allow the push rod to move in a non-linear or flexing motion without damaging the sealing member or the adapter base aperture. The second bushing member preferably has a generally upstanding inner wall and a radially disposed generally upstanding outer wall that are configured such that at least a portion of the inner wall and the outer wall are in spaced apart relation to each other and form a channel therebetween so as to comprise a non-continuous bushing member across the top thereof to allow for greater flexibility with regard to the movement of the push rod through the adapter base aperture. In the preferred embodiment, the inner wall and the outer wall are interconnected near a lower end of the inner wall and a lower end of the outer wall. The engagement tabs for locking in the aperture groove are placed on the outside of the outer wall and are at least partially received in the aperture groove. In the preferred embodiment, a shock absorbing element, such as an o-ring is disposed in the channel to provide additional force to direct the engagement tabs inside the aperture groove and provide stiffening for the outer wall. Alternatively, the shock absorbing element may be a leaf spring member or an over-molded or co-injected elastomer. The shock absorbing element can be held in place in the channel with the use of one or more securing tabs on the inner wall of the second bushing member. The outer wall can be configured with a plurality of circumferentially disposed wall segments to provide additional flexibility therefor. In another general aspect of the present invention, the above-described bushing assembly is incorporated in a spring brake actuator utilized in spring brake systems. The improved bushing assembly and spring brake actuator of the present invention reduces the likelihood that non-linear or flexing movement of the push rod will damage the bushing sealing member or the aperture, resulting in the inability of the braking system to function properly.

Accordingly, it is a primary objective of the present invention to provide a flexible bushing assembly for push rod center seals used in spring brake actuators that provides the advantages discussed above and that overcomes the disadvantages and limitations associated with presently configured center seals.

It is also a primary objective of the present invention to provide a flexible bushing assembly for spring brake push rod center seals that effectively seals the push rod as it moves through the center seal of an adapter base separating a pressurized chamber from a non-pressurized chamber while allowing for non-linear or flexing movement of the push rod to reduce or eliminate the likelihood of excessive wear on the center seal component that can result in leaks and loss of braking system effectiveness.

It is also an important objective of the present invention to provide a flexible bushing assembly for spring brake push rod center seals that comprises a non-continuous bushing member which is received into the aperture of the adapter base to form a center seal that is configured to sealably receive the spring brake push rod therein so as to allow the push rod to flex while it moves through the center seal.

It is also an important objective of the present invention to provide a flexible bushing assembly for a spring brake push rod center seal that comprises a first bushing member adapted to be received against a lip formed inside the adapter base aperture, a second bushing member having a non-continuous cross-section on the opposite end of the aperture and a sealing member configured to be disposed between the first bushing member and the second bushing member.

It is also an important objective of the present invention to provide a flexible bushing assembly for a spring brake push rod center seal that comprises a mechanism in the adapter base aperture for securely receiving the bushing assembly and a cooperatively configured bushing assembly component for securing the bushing assembly in the adapter base aperture.

It is also an important objective of the present invention to provide a flexible bushing assembly for a spring brake push rod center seal that comprises at least one snap-in center seal bushing member configured with a tubular shaped inner wall for sealably receiving a push rod therein and an interconnected outer wall that is substantially in spaced apart relation to the inner wall and configured to engage a cooperatively configured groove in the adapter base aperture for secure mounting therein.

The above and other objectives of the present invention will be explained in greater detail by reference to the attached figures and the description of the preferred embodiment which follows. As set forth herein, the present invention resides in the novel features of form, construction, mode of operation and combination of components presently described and understood by the claims.

### BRIEF DESCRIPTION OF THE DRAWINGS

In the drawings which illustrate the preferred embodiments and the best modes presently contemplated for carrying out the present invention:

FIG. 1 is a cross-sectional side view of a double diaphragm spring brake actuator constructed in accordance with a preferred embodiment of the present invention;

FIG. 2 is an isolated cross sectional view of the center seal area of the brake actuator of FIG. 1 particularly illustrating a flexible bushing assembly configured according to a preferred embodiment of the present invention;

FIG. 3 is a top perspective view of the upper or second bushing member of the flexible bushing assembly shown in FIG. 2 configured according to a preferred embodiment of the present invention;

FIG. 4 is an exploded side view of the flexible bushing assembly and cooperatively configured adapter base aperture shown in FIG. 2 configured according to a preferred embodiment of the present invention;

FIG. 5 is a top view of an alternative embodiment of the upper or second bushing member of a flexible bushing configured according to a preferred embodiment of the present invention;

FIG. 6a is an isolated top view of the leaf spring used in the upper or second bushing member of FIG. 5; FIG. 6b is an isolated top view of an alternative embodiment of a leaf spring for use in the upper or second bushing member of FIG. 5;

FIG. 6c is an isolated top view of a second alternative embodiment of a leaf spring for use in the upper or second bushing member of FIG. 5;

FIG. 7 is an isolated cross sectional view of the center seal area of the brake actuator of FIG. 1 particularly illustrating a flexible bushing assembly configured according to an alternative embodiment of the present invention using a snap ring;

FIG. 8 is an isolated cross sectional view of the center seal area of the brake actuator of FIG. 1 particularly illustrating a flexible bushing assembly configured according to an alternative embodiment of the present invention using a single piece or integral bushing member;

FIG. 9 is an isolated cross sectional view of the center seal area of the brake actuator of FIG. 1 particularly illustrating a flexible bushing assembly configured according to an alternative embodiment of the present invention using a screw-in upper or second bushing member;

FIG. 10 is an isolated cross sectional view of the center seal area of the brake actuator of FIG. 1 particularly illustrating a flexible bushing assembly configured according to an alternative embodiment of the present invention with the upper or second bushing member being held in place by crimping the adapter base; and

FIG. 11 is an isolated cross sectional view of the center seal area of the brake actuator of FIG. 1 particularly illustrating a flexible bushing assembly configured according to an alternative embodiment of the present invention using a co-injection or overmolded shock absorbing material.

### DETAILED DESCRIPTION OF THE PREFERRED EMBODIMENTS

With reference to the figures where like elements have been given like numerical designations to facilitate the reader's understanding of the present invention, and particularly with reference to the embodiments of the flexible bushing assembly for the spring brake push rod center seal of the present invention illustrated in the figures, various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein. For purposes of this disclosure, references are generally to use of the present invention with a double diaphragm spring brake actuator, however, it is understood that the disclosure herein applies to other types of spring brake actuators having a push rod extending through a center seal opening.

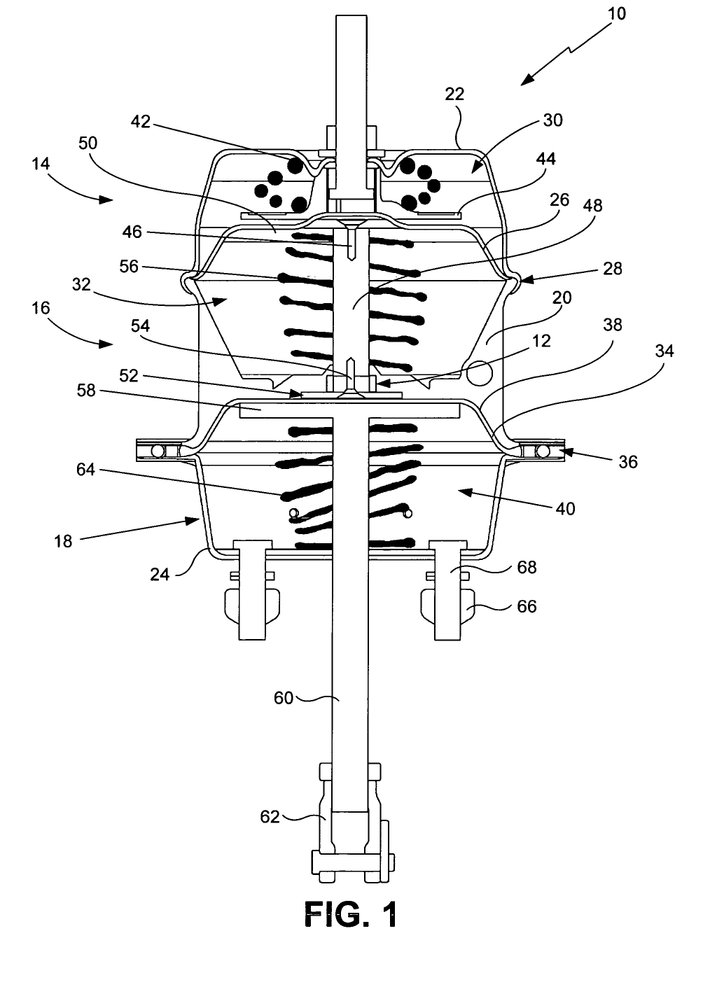

A preferred embodiment of a spring brake actuator that is manufactured out of the components and configured pursuant to the concepts and principles of the present invention is shown generally as 10 in the figures. As shown generally in FIG. 1, spring brake actuator 10 is particularly configured for use with the improved flexible bushing assembly 12 of the present invention, as is set forth in more detail below and in the accompanying figures. The embodiment of the spring brake actuator 10 shown in FIG. 1 generally comprises a parking brake section 16 and service brake section 18. As shown, adapter base 20 separates parking brake section 16 and service brake section 18, forming the lower wall of parking brake section 16 and the upper wall of service brake section 18. In some spring brake adapters 10, adapter base 20 is formed from one or more adapter plates. Generally, adapter base 20 is made out of aluminum or other metals. Spring housing 22 is the upper wall of parking brake section 16 and service housing 24 is the lower wall of service brake section 18. An elastic parking chamber diaphragm 26, extending across the upper end of adapter base 20 at parking brake clamp 28, divides parking brake section 16 into a non-pressurized spring chamber 30 and a pressurized parking brake chamber 32. An elastic service chamber diaphragm 34, extending across the lower end of adapter base 20 at service brake clamp 36, divides service brake section 18 into a pressurizable upper service chamber 38 and a non-pressurized lower service chamber 40. The main compression spring 42 is disposed in spring chamber 30 generally between spring housing 22 and a moveable spring pressure plate 44. Spring pressure plate 44 is configured to move downward against parking chamber diaphragm 26 and upper push rod plate 46, which is attached to push rod 48 by upper adapter base push rod screw 50. At the opposite end of push rod 48 is lower push rod plate 52, which is connected to push rod 48 by lower adapter base push rod screw 54. As set forth in more detail below, the movement of main spring 42 against parking chamber diaphragm 26 and upper push rod plate 46 drives push rod 48 downward through flexible bushing or center seal assembly 12, which is in sealable relation to push rod 48 to allow push rod 48 to move therethrough without loss of pressure from the pressurized parking brake chamber 32. Parking return spring 56, disposed in parking brake chamber 32 around push rod 48, returns upper push rod plate 46 to its non-braking position, as is generally shown in FIG. 1.

Lower push rod plate 52 is configured to push downward against service chamber diaphragm 40 and actuator rod plate 58 to drive actuator rod 60 in a generally downward direction. Clevis 62, or other operating mechanism at the opposite end of actuator rod 60 from actuator rod plate 58, is configured to operatively couple to the vehicle's braking system (not shown) to brake the vehicle when actuator rod 60 is driven downward by the action of service chamber diaphragm 40 against actuator rod plate 58, which as described below occurs either as a result of action by lower push rod plate 52 or the pressurization of upper service chamber 38. Service return spring 64 is configured to return actuator rod plate 58 and, therefore, actuator rod 60 to the non-braking condition shown in FIG. 1. Typically, brake actuator 10 is mounted in place on the vehicle by the attachment of mounting nut 66 to threaded mounting bolt 68. A hydraulic system (not shown) hydraulically connects to parking brake chamber 32 and to upper service chamber 38 to add or remove pressurized fluid (i.e., air) from pressurized parking brake chamber 32 or upper service chamber 38 to set or unset, as the case may be, the vehicle's parking brake or service brakes.

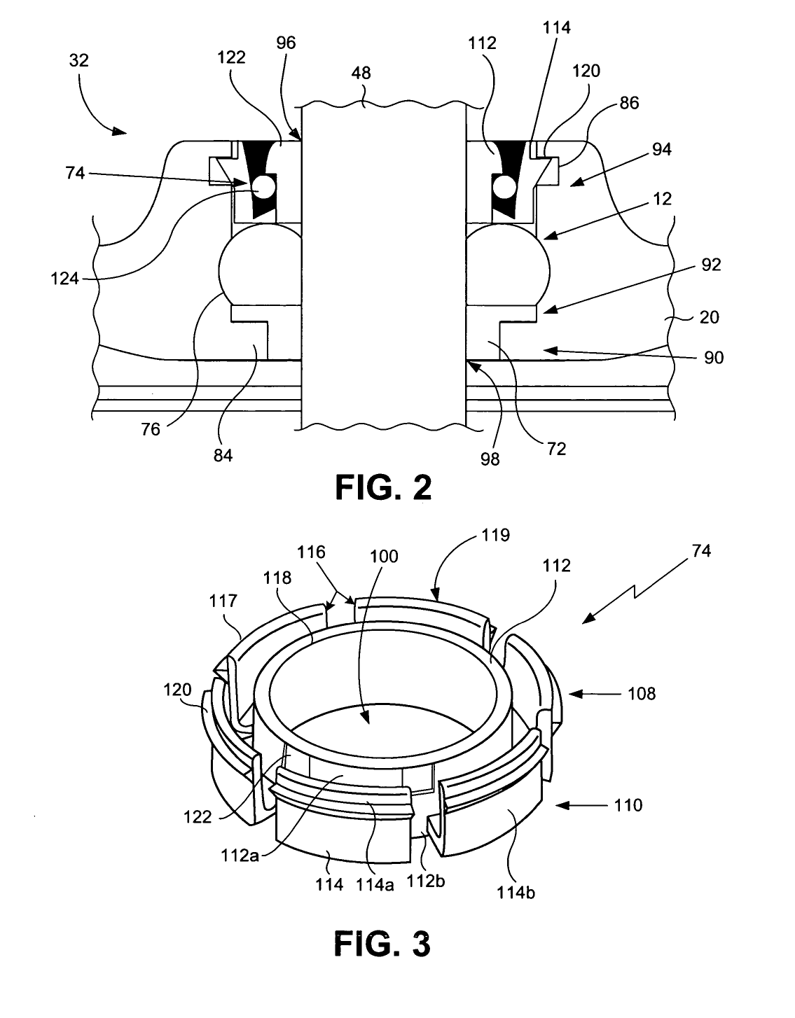

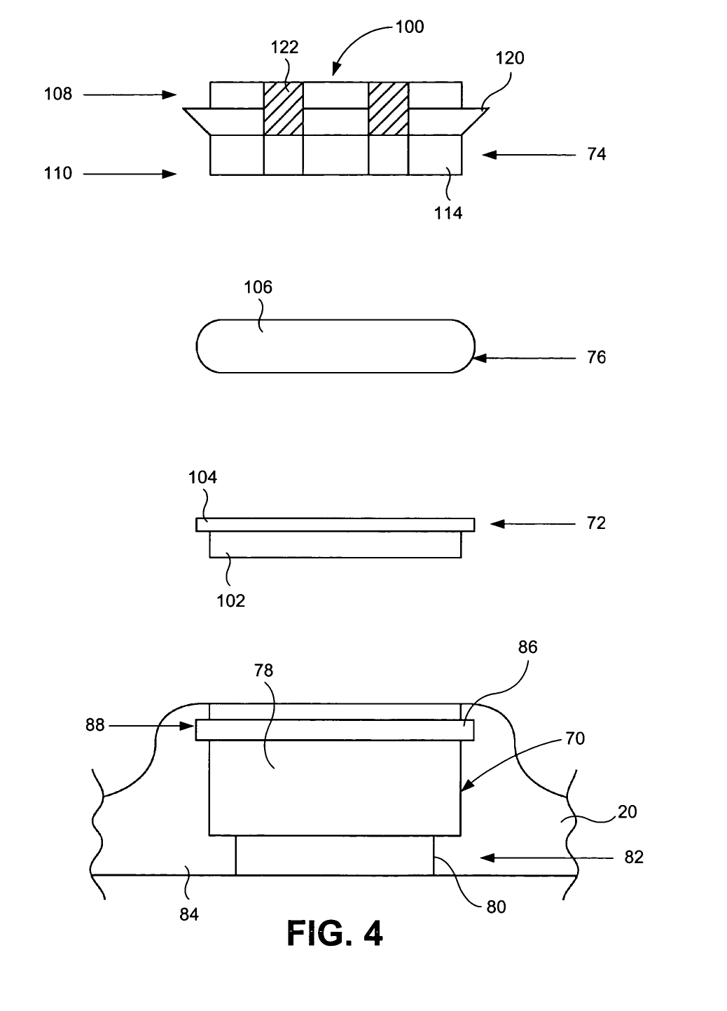

In operation during normal driving or non-braking condition, shown generally in FIG. 1, the pressure inside parking brake chamber 32 exceeds the compression force of main spring 42, parking return spring 56 biases upper push rod plate 46 upward against parking chamber diaphragm 26 and service return spring 64 biases actuator rod plate 58 against service chamber diaphragm 34 toward the lower end of adapter base 20. When the driver presses the brake pedal (not shown) to reduce the vehicle's speed or stop the vehicle, pressurized air or other fluid is directed into upper service chamber 38, thereby causing it to expand and force service chamber diaphragm 34 downward against actuator rod plate 58 to drive actuator rod 60 away from brake actuator 10 to cause clevis 62 to operatively engage the vehicle's braking system (not shown). When the driver stops the vehicle and sets the parking brake to keep the vehicle in a stopped condition, air or other hydraulic fluid is released from the pressurized parking brake chamber 32 such that the force of main compression spring 42 exceeds the pressure in parking brake chamber 32, thereby causing main spring 42 to bias spring pressure plate 44 and parking chamber diaphragm 26 against upper push rod plate 46 disposed in parking brake chamber 32 to drive push rod 48 in a generally downward direction. Push rod 48 sealably moves through center seal bushing assembly 12 disposed in an aperture 70, best shown in FIGS. 2 and 4, in adapter base 20 to mechanically drive service chamber diaphragm 34 against actuator rod plate 58, which in turn drives actuator rod 60 away from brake actuator 10 to cause clevis 62 to operatively engage the vehicle's braking system. If the vehicle's braking system inadvertently loses pressure, for instance due to a leak in a pressure line or some other loss of hydraulic pressure, then brake actuator 10 will automatically operate in the manner described above for setting the vehicle's parking brake (i.e., push rod 48 will drive service chamber diaphragm 34 against actuator rod plate 58 to drive actuator rod 60 outwardly of the brake actuator 10).

As discussed above, one of the primary maintenance and operational problems with the spring brake actuator systems heretofore utilized on larger trucks and commercial vehicles, pertains to the wear on the center seal area of adapter base 20 due to non-linear or flexing movement of push rod 48 therethrough. The non-linear or flexing movement of push rod 48 can result from uneven wear of main spring 42, due to the manufacturing of main spring 42 itself, or from the assembly of brake actuator 10 that results in a somewhat off-center main spring 42. This non-linear or flexing movement of push rod 48 through the center seal area is well known to cause excessive wear of the seal and wear away the aperture 70 of adapter base 20. Much of the wear is a direct result of the inability of the center seal to withstand the non-linear or flexing movement of push rod 48. This wear will ultimately result in the parking brake chamber 32 being unable to hold pressure, thereby causing the vehicle to be perpetually placed in a parking brake condition (i.e., where the force of main spring 42 exceeds the pressure inside parking brake chamber 32). Naturally, this results in the vehicle being generally inoperable. The bushing assembly 12 of the present invention for the center seal in aperture 70 of adapter base 20, solves the problems of excessive wear by allowing for this non-linear or flexing movement of push rod 48 through bushing assembly 12.

A preferred embodiment of the bushing assembly 12 for adapter base 10 of the present invention, shown in FIGS. 2 through 4, comprises a first bushing member 72, a second bushing member 74 and a sealing member 76 disposed between first bushing member 72 and second bushing member 74. As set forth in more detail below, these components are configured to sealably receive push rod 48 and allow it to flex therein without causing significant premature wear to bushing assembly 12 or aperture 70 of adapter base 20. For the bushing assembly 12 of the present invention, aperture 70 of adapter base 20 is disposed at substantially the center of adapter base 20 and is configured with a first aperture section 78 having a cross-sectional diameter sufficient to receive the components of bushing assembly 12, a second aperture section 80 at the lower end 82 of aperture 70 that, in the preferred embodiment has a cross-sectional diameter which is less than first aperture section 78 so as to form circumferential lip extension 84 of adapter base 20, and a locking groove 86 at or near the upper end 88 of aperture 70, as best shown in FIG. 4. As described in more detail below, first aperture section 78, second aperture section 80 and locking groove 86 cooperatively engage the components of bushing assembly 12 to provide a sealing assembly that sealably allows push rod 48 to pass therethrough without substantial wear resulting from non-linear or flexing motion of push rod 48. In the preferred embodiment, adapter base 20 is machined to have first aperture section 78, second aperture section 80 and locking groove 86 in aperture 70.

In the embodiment shown in FIGS. 2 through 4, bushing assembly 12 of the preferred embodiment has a guiding section 90 to assist in guiding the passage of push rod 48 through aperture 70, a sealing section 92 to seal against push rod 48 and a flexing section 94 to allow for the non-linear or flexing motion of push rod 48 as it passes through aperture 70. In this embodiment, first bushing member 72 is the guiding section 90, sealing member 76 is the sealing section 92 and second bushing member 74 is the flexing section 94 of bushing assembly 12. These components form a generally cylindrical bushing assembly 12 having a first end 96 at parking brake chamber 32 and a second end 98 at upper service chamber 38 of brake actuator 10 with an axial opening 100 disposed therebetween for receiving push rod 48 therein. In the embodiment of FIGS. 2 through 4, flexing section 94 is disposed at first end 96 and guiding section 90 is disposed at second end 98 of bushing assembly 12. In this embodiment, first bushing member 72 comprises a ring or ring-like member that has a lower section 102 which is sized and configured to fit within second aperture section 80 and an upper section 104 which is sized and configured to fit within first aperture section 78 and generally abut lip extension 84, as best shown in FIG. 2. The opening of first bushing member 72 is configured to be in longitudinal axial alignment with the longitudinal axis of aperture 70. First bushing member 72 can be made out of a variety of different materials known by those skilled in the art to be suitable for use as a generally effective barrier between push rod 48 and aperture 70. In a preferred embodiment, first bushing member 72 is made out of a thermoplastic or thermosetting polymer, such as nylon or a nylon-based material, which is suitable for forming first bushing member 72 by an injection molding process. Also in the preferred embodiment, sealing member 76 comprises an elastomeric ring 106, which can be made out of rubber or a rubber-like material, that is sized and configured to fit tightly within first aperture section 78 of aperture 70 and rated for temperatures suitable for use with brake adapter 10 (i.e., rated to temperatures of −40° F. to +175° F.). In a preferred embodiment, sealing member 76 is an 0-ring type of seal that is commonly utilized in the art. Alternatively, sealing member 76 can be a quad-ring (X-ring) or a specially configured component (as set forth below) which is configured for use as part of bushing assembly 12 of the present invention.

In the preferred embodiment, flexing section 94 comprises second bushing member 74 that is specially configured to allow push rod 48 to move in a generally non-linear or flexing motion through aperture 70 of adapter base 20. In this embodiment, as best shown in FIG. 3, second bushing member 74 comprises a top end 108 and an opposing bottom end 110, which when installed in aperture 70 will abut the top of sealing member 76 to secure sealing member 76 inside aperture 70. Axial opening 100 is generally disposed between top end 108 and bottom end 110 such that the longitudinal axis of second bushing member 74 is generally axially aligned with the longitudinal axis of aperture 70 and the other components of bushing assembly 12. To provide for the flexing of push rod 48, second bushing member 74 comprises an inner wall 112 and a radially disposed outerwall 114, which form channel 116 therebetween. In the preferred embodiment, channel 116 is generally u-shaped. Also in the preferred embodiment, upper end 112a of inner wall 112 is in spaced apart relation to upper end 114a of outer wall 114 such that outer wall 114 can flex relative to inner wall 112. As such, second bushing member 74 is substantially open or non-continuous across the top end 108 thereof.

Inner wall 112 has an inner surface 118 that, in the preferred embodiment, is configured to be generally smooth so as to slidably abut push rod 48 as it moves through opening 100 during use of brake adapter 10 of the present invention. Outer wall 114 is sized and configured to fit somewhat tightly or snugly inside first aperture section 78 of aperture 70. To facilitate the insertion of second bushing member 74 in aperture 70 and the desired flexing for push rod 48, outer wall is divided into a plurality of spaced apart, circumferentially disposed wall segments 119 (six are shown in FIG. 3). To secure second bushing member 74 and bushing assembly 12 inside aperture 70, second bushing member 74 of the preferred embodiment is provided with one or more generally outwardly extending locking elements, such as engagement tabs 120, which are sized and configured to cooperatively engage locking groove 86 of aperture 70. In the embodiment shown in FIG. 3, six locking elements 120 are utilized, one on each of wall segments 119. In the preferred embodiment, outer wall 114 is interconnected with inner wall 112 at or near the bottom end 110 thereof (i.e., at lower end 112b of inner wall 112 and lower end 1 14b of outer wall 114) such that the upstanding portion of outer wall 114 will flex inward toward channel 116 when second bushing member 74 is installed inside aperture 70 and then snap engagement tabs 120 outwardly into place in locking groove 86. This snap-in action will lockingly secure second bushing member 74 and, as a result, sealing member 76 and first bushing member 72 between second bushing member 74 and lip extension 84. Once in place inside aperture 70 with push rod 48 passing through axial opening 100 formed partially by inner surface 118, second bushing member 74 will allow push rod 48 to travel in a generally non-linear or flexing motion, typically as a result of side loading by main spring 42, without contacting and causing excessive wear against sealing member 76 and aperture 70 of adapter base 20, thereby better maintaining the seal between parking brake chamber 32 and upper service chamber 38. The second bushing member 74 assists first bushing member 72 in preventing contact between push rod 48 and aperture 70 of adapter base 20 and, as such, reduces or eliminates the negative effects of the side loading from main spring 42. In a preferred embodiment, second bushing member 74 is made out of a thermoplastic or thermosetting polymer, such as nylon or a nylon-based material, which is suitable for forming second bushing member 74 by an injection molding process. In the preferred embodiment shown in FIGS. 2 through 4, second bushing member 74 also comprises one or more securing tabs 122 that are sized and configured to secure a shock absorbing element 124. In the embodiment shown in FIG. 2, shock absorbing element 124 is an o-ring or ring-like member that is configured to be held in place by six securing tabs 122. If desired or necessary, depending on the materials and configuration of second bushing member 74, shock absorbing element 124 can provide additional lateral force to securing tabs 120 so as to better engage them in locking groove 86. In addition, shock absorbing element 124 can reduce problems that may occur with too much flexing of outer wall 114. In an alternative embodiment outer wall 114 and the remainder of second bushing member 74 are configured such that shock absorbing element 124 is not necessary (i.e., engagement tabs 120 stay in locking groove 86 sufficiently well without shock absorbing element 124). Such an arrangement will likely reduce the overall cost of manufacturing bushing assembly 12.

The bushing assembly 12 of the preferred embodiment is installed by inserting first bushing member 72 into second aperture section 80 at the lower end 82 of aperture 70 such that lower section 102 is disposed inside second aperture section 80 and the bottom side of upper section 104 is in abutting relationship with lip extension 84. Once first bushing member 72 is in place, sealing member 76 is placed inside first aperture section 78 of aperture 70 in abutting relation with the top side of upper section 104. Generally, an appropriate grease or other lubricant will be applied to sealing member 76 to aid in assembly thereof inside aperture 70. Once sealing member 76 is installed, additional grease or other lubricant can be applied to the interior axial opening 100 thereof to aid in lubricating push rod 48 as it slides past sealing member 76 during use of brake adapter 10. Second bushing member 74 is then inserted into first aperture section 78 of aperture 70 until the bottom end 110 thereof abuts the top side of sealing member 76 and engagement tabs 120 snap into locking groove 86. Once in place, second bushing member 74 will secure first bushing member 72 against lip extension 84 and sealing member 76 against first bushing member 72, between first bushing member 72 and second bushing member 74, to form a somewhat unitary bushing assembly 12 inside aperture 70 of adapter base 20. If shock absorbing element 124 is utilized, generally it will be put into place and secured by securing tabs 122 in channel 116 between outer wall 114 and inner wall 112 prior to second bushing member 74 being inserted into aperture 70. However, shock absorbing element 124 can be installed after second bushing member 74 is placed in aperture 70. First bushing member 72, in conjunction with second bushing member 74, eliminates the metal to metal wear that is known to be common with previous configurations for spring brake adapters. As a result, longer equipment life and less maintenance costs will be achieved.

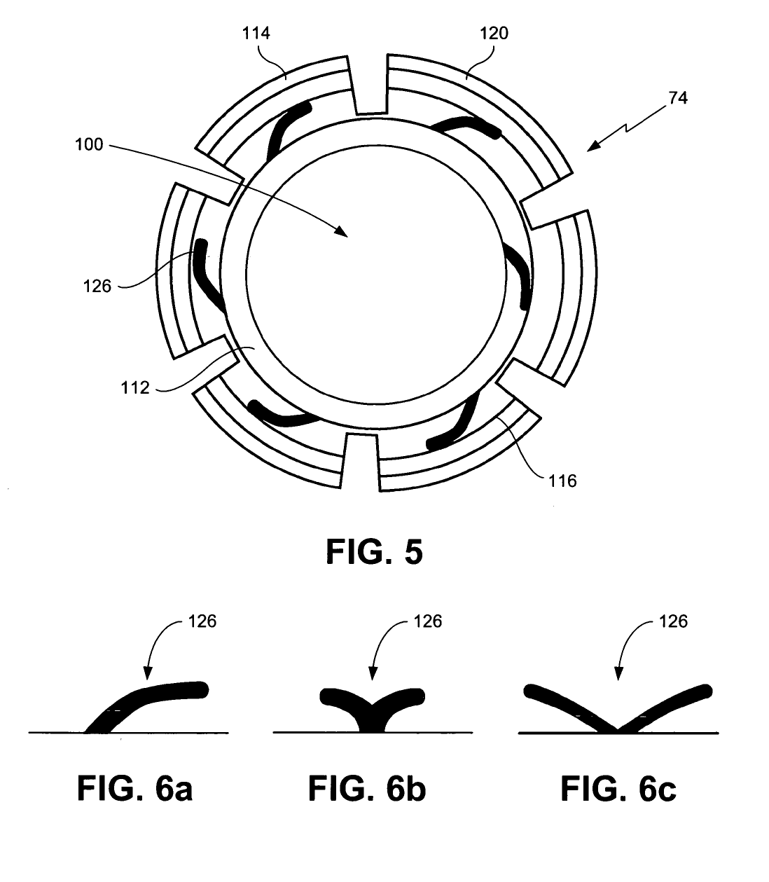

An alternative embodiment of second bushing member 74 is shown in FIG. 5. In this embodiment, the o-ring or ring-like configuration for shock absorbing element 124 is replaced with a plurality of leaf spring members, shown as 126, which are disposed in channel 116 and configured to provide the same benefits of the o-ring or ring-like member described above, namely provide additional force to securing tabs 120 so as to better engage them in locking groove 86 and reduce problems that may occur with too much flexing of outer wall 114. As known to those skilled in the art, leaf spring members 126 can be made out of metal or a variety of plastics, such as a thermal plastic or thermal set polymer, that is molded into channel 116 or such plastics or metal leaf spring members that are placed in channel 116 during the manufacturing process thereof. Leaf spring members 126 can be made out of a variety of different configurations that are well known in the art, examples of which are shown in FIGS. 6a, 6b and 6c.

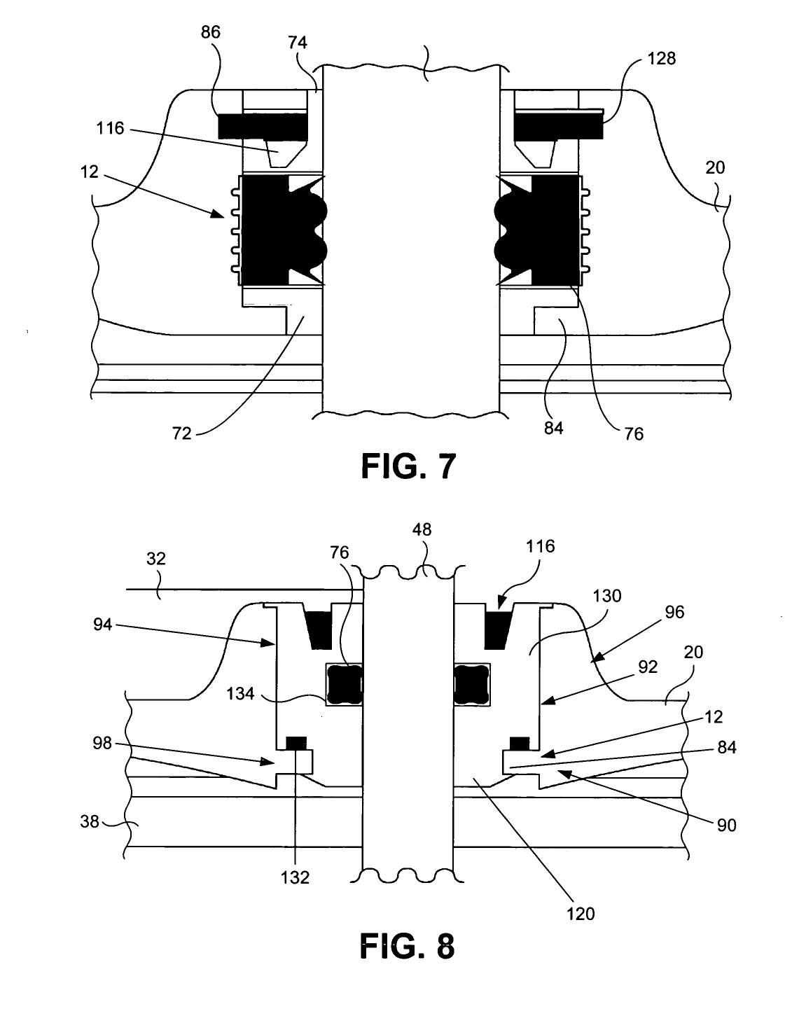

In the embodiment shown in FIG. 7, bushing assembly 12 utilizes a snap-ring element 128 at second bushing member 74 to lockingly engage locking groove 86. In the embodiment shown, second bushing member 74 is configured substantially the same as first bushing member 72 with snap-ring element 128 disposed around it in a manner that allows snap-ring element 128 to cooperatively engage locking groove 86. As with the embodiment shown in FIGS. 2 through 4, first bushing member 72 is positioned in abutting relation with lip extension 84 and then sealing member 76, which is shown as a quad-ring type of member, is positioned on top of first bushing member 72. Second bushing member 74, with snap-ring element 128 disposed thereon, is placed into position on top of sealing member 76 so as to engage locking groove 86 and secure second bushing member 74, as well as sealing member 76 and first bushing member 72, in aperture 70. As described above, sealing member 76 sealably engages push rod 48 to prevent passage of pressurized fluid from parking brake chamber 32 and upper service chamber 38. As with the previous embodiment, this configuration will allow sufficient flexibility for bushing assembly 12 to allow push rod to travel in a non-linear or flexing direction without damaging sealing member 76 or aperture 70.

The embodiment of FIG. 8 illustrates the use of a single or unitary bushing member 130 for bushing assembly 12. In this embodiment, the guiding section 90 at second end 98 of bushing assembly 12 is configured with locking element 120 that is configured to lockingly engage lip extension 84 of adapter base 20. Preferably, a second sealing member 132 is utilized to ensure that pressurized fluid cannot pass between bushing member 130 and aperture 70. Sealing section 92 of bushing assembly 12 comprises a sealing groove 134 configured to receive sealing member 76 therein and secure it in a sealing relationship with push rod 48. With sealing member 76 disposed in sealing groove 134, pressurized fluid cannot pass between bushing member 130 and push rod 48. Flexing section 94 at first end 96 of bushing member 130 is preferably configured as described above with regard to the flexing components of FIGS. 2 and 3 (i.e., inner wall 112, outer wall 114, channel 116 and wall segments 119) to allow push rod 48 to pass therethrough in a non-linear or flexing manner without damaging sealing member 76 and aperture 70 due to contact with push rod 48. If desired, a shock absorbing element, such as o-ring 124 or leaf spring member 126, can be utilized in channel 116 for the purposes described above.

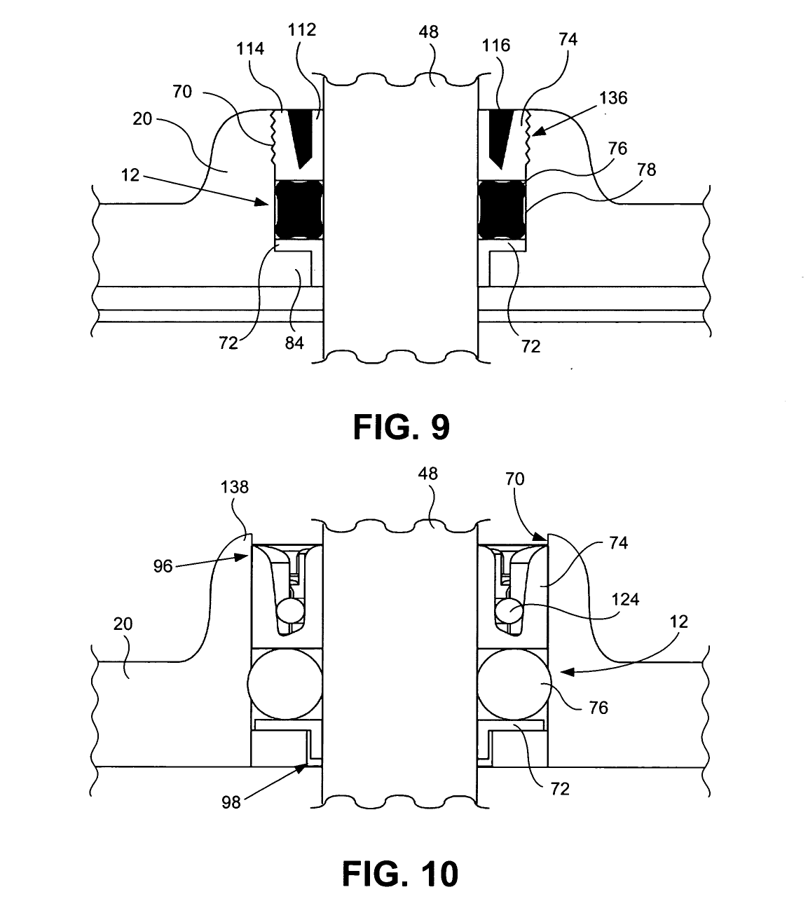

In the embodiment of FIG. 9, bushing assembly 12 is configured as set forth above in FIGS. 2 through 4 except that second bushing member 74 is configured with a threaded section 136 which is threadably engaged in aperture 70, instead of the snap-in configuration using engagement tabs 120. As with the above embodiment, first bushing member 72 is positioned in abutting relation with lip extension 84 and then sealing member 76, which is shown as an X-ring type of member, is placed on top of first bushing member 72 in first aperture section 78. Second bushing member 74, with threaded section 136, is threaded into a cooperatively configured aperture 70 so as to secure it and the other components of bushing assembly 12 in aperture 70. Second bushing member 74 can comprise the flexing components described with regard to FIGS. 2 and 3 (i.e., inner wall 112, outer wall 114, channel 116 and wall segments 119) to allow push rod 48 to pass therethrough in a non-linear or flexing manner without damaging sealing member 76 and aperture 70 due to contact with push rod 48. If desired, a shock absorbing element, such as o-ring 124 or leaf spring member 126, can be utilized in channel 116 for the purposes more fully described above.

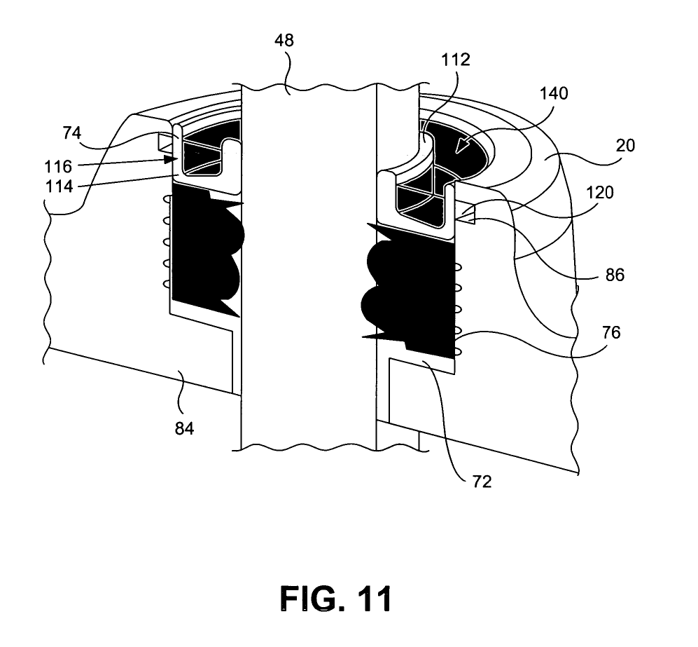

In the embodiment of FIG. 10, bushing assembly 12 is configured as set forth above in FIGS. 2 through 4 except that second bushing member 74 is configured without engagement tabs 120 (i.e., outer wall 114 is configured to be generally smooth). Instead, of utilizing engagement tabs 120, snap ring element 128, threaded section 136 or other mechanisms to cooperatively engage with aperture 70 of adapter base 20, the embodiment of FIG. 10 has a crimped portion 138 at the upper end of aperture 70 that engages the first end 96 of the center seal bushing assembly 12 to hold it in place in aperture 70 of adapter base 20. In this configuration, bushing assembly 12 and/or adapter base 20 will have to be configured that first end 96 of bushing assembly 12 will sit below the upper end of aperture 70 so that a portion thereof can be crimped over the bushing assembly 12. In the embodiment shown in FIG. 10, crimped portion 138 operatively engages (i.e., in abutting relation) the top of second bushing member 74 to hold bushing assembly 12 in aperture 70 of adapter base 20. The crimping of crimped portion 138 can be accomplished by a variety of different processes well known to those skilled in the art.

In another alternative embodiment, shown in FIG. 11, shock absorbing element 124 is an over-molded elastomer or co-injected elastomer, shown as 140, disposed inside channel 116 during the manufacturing process. As shown in FIG. 10, first bushing member 72 is disposed against lip extension 84 of adapter base 20 and sealing member 76 (a specially configured sealing member 76 is shown in FIG. 11) is positioned against first bushing member 72, with second bushing member 74 securing the other components of bushing assembly 12 inside aperture 70. As described above, engagement tabs 120 can be lockingly engaged in locking groove 86. In this embodiment, the over-molded elastomer or co-injected elastomer 140 is placed in channel 116 between inner wall 112 and outer wall 114 to provide the shock absorbing and stiffening benefits described above with regard to the o-ring of FIG. 2 and leaf spring member 126.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use. For instance, there are numerous components described herein that can be replaced with equivalent functioning components to accomplish the objectives of the present invention.

What is claimed is:

1. A bushing assembly for allowing a push rod to pass through an aperture in an adapter base separating a first pressure chamber from a second pressure chamber in a spring brake actuator, said bushing assembly comprising:
a generally cylindrical bushing member having a first end and a second end and an axial opening disposed therebetween, said axial opening configured to slidably receive said push rod therein, said bushing member having a locking element, a flexing section and a sealing section, said locking element configured to lockingly engage said aperture to secure said bushing member in said aperture, said flexing section configured to generally allow flexing movement of said push rod through said aperture; and
a sealing member secured in said bushing member by said sealing section of said bushing, said sealing member configured to sealingly engage said push rod so as to prevent passage of a pressurized fluid between said first pressure chamber and said second pressure chamber.

2. The bushing assembly of claim 1, wherein said sealing section comprises a sealing groove in said bushing member, said sealing member at least partially disposed in said sealing groove.

3. The bushing assembly of claim 1, wherein said flexing section is generally toward said first end of said bushing member and said locking element is generally toward said second end of said bushing member.

4. The bushing assembly of claim 1, wherein said flexing section and said locking element are generally at said first end of said bushing member.

5. The bushing assembly of claim 1, wherein said aperture comprises a locking groove, said locking element configured to cooperatively engage said locking groove to secure said bushing member in said aperture.

6. The bushing assembly of claim 5, wherein said locking element comprises one or more engagement tabs disposed on said bushing member.

7. The bushing assembly of claim 5, wherein said locking element comprises a snap-ring element attached to said bushing member.

8. The bushing assembly of claim 1, wherein said locking element lockingly engages a lip extension of said adapter base.

9. The bushing assembly of claim 1, wherein said locking element comprises a threaded section of said bushing member, said threaded section threadably received in said aperture.

10. The bushing assembly of claim 1, wherein said flexing section comprises a generally upstanding inner wall and a radially disposed generally upstanding outer wall, said inner wall and said outer wall in spaced apart relation and forming a channel therebetween.

11. The bushing assembly of claim 10, wherein said inner wall and said outer wall are interconnected near a lower end of said inner wall and a lower end of said outer wall.

12. The bushing assembly of claim 11, wherein said channel is generally u-shaped.

13. The bushing assembly of claim 10, wherein said locking element comprises one or more engagement tabs on said outer wall.

14. The bushing assembly of claim 13, wherein said engagement tabs are configured to be at least partially received in a locking groove disposed in said aperture.

15. The bushing assembly of claim 10, wherein said bushing member further comprises a shock absorbing element received in said channel.

16. The bushing assembly of claim 15, wherein said shock absorbing element is retained in said channel by one or more securing tabs on said inner wall.

17. The bushing assembly of claim 10, wherein said outer wall comprises a plurality of circumferentially disposed wall segments.

18. A bushing assembly for allowing a push rod to pass through an aperture in an adapter base separating a first pressure chamber from a second pressure chamber in a spring brake actuator, said bushing assembly comprising:
a generally cylindrical first bushing member;
a generally cylindrical second bushing member having a top end and a bottom end and an axial opening disposed therebetween and configured to slidably receive said push rod therein, said second bushing member having a locking element configured to lockingly engage said aperture to secure said second bushing member in said aperture, said second bushing member configured to generally allow flexing movement of said push rod through said aperture; and
a sealing member disposed between said first bushing member and said second bushing member, said sealing member configured to sealingly engage said push rod so as to prevent passage of a pressurized fluid between said first pressure chamber and said second pressure chamber.

19. The bushing assembly of claim 18, wherein said second bushing member comprises a generally upstanding inner wall and a radially disposed generally upstanding outer wall, said inner wall and said outer wall in spaced apart relation and forming a channel therebetween.

20. The bushing assembly of claim 19, wherein said inner wall and said outer wall are interconnected near a lower end of said inner wall and a lower end of said outer wall.

21. The bushing assembly of claim 19, wherein said locking element comprises one or more engagement tabs on said outer wall.

22. The bushing assembly of claim 21, wherein said engagement tabs are configured to be at least partially received in a locking groove disposed in said aperture.

23. The bushing assembly of claim 19, wherein said bushing member further comprises a shock absorbing element received in said channel.

24. The bushing assembly of claim 23, wherein said shock absorbing element is retained in said channel by one or more securing tabs on said inner wall.

25. The bushing assembly of claim 19, wherein said outer wall comprises a plurality of circumferentially disposed wall segments.

26. The bushing assembly of claim 18, wherein said aperture comprises a locking groove, said locking element configured to cooperatively engage said locking groove to secure said bushing member in said aperture.

27. The bushing assembly of claim 26, wherein said locking element comprises one or more engagement tabs disposed on said bushing member.

28. The bushing assembly of claim 26, wherein said aperture further comprises first aperture section and a second aperture section, said locking groove disposed in said first aperture section, said second aperture section forming a lip extension in said aperture, said first bushing member configured to abut said lip extension.

29. A spring brake actuator, comprising:
an adapter base separating a first pressure chamber from a second pressure chamber;
a first housing attached to an upper end of said adapter base to enclose said first chamber;
a second housing attached to a lower end of said adapter base to enclose said second chamber;
a push rod disposed in said first pressure chamber, said push rod configured to extend through an aperture in said adapter base and into said second pressure chamber; and
a bushing assembly disposed in said aperture, said bushing assembly configured to sealably receive said push rod so as to facilitate passage of said push rod through said adapter base while maintaining a fluid tight seal between said first pressure chamber and said second pressure chamber, said bushing assembly having a flexing section configured to allow flexing movement of said push rod through said aperture and at least one sealing member configured to sealingly engage said push rod to prevent passage of pressurized fluid between said first pressure chamber and said second pressure chamber; and
means at said aperture for securing said bushing assembly in said aperture.

30. The spring brake actuator of claim 29, wherein said securing means comprises a crimped portion of said adapter base.

31. The spring brake actuator of claim 30, wherein said bushing assembly comprises a cylindrical first bushing member, a cylindrical second bushing member and a sealing member disposed in said aperture between said first bushing member and said second bushing member, said first bushing member disposed in said aperture and configured to generally allow said push rod to pass therethrough without contacting said aperture, said cylindrical second bushing member disposed in said aperture, said crimping portion configured to cooperatively engage said second bushing member so as to secure said bushing assembly in said aperture, said second bushing member configured to generally allow flexing movement of said push rod through said aperture, said sealing member configured to sealingly engage said push rod and prevent passage of pressurized fluid between said first pressure chamber and said second pressure chamber.

32. The spring brake actuator of claim 31, wherein said aperture has a first aperture section and a second aperture section, said second aperture section forming a lip extension in said aperture, said first bushing member configured to abut said lip extension.

33. The spring brake actuator of claim 31, wherein said second bushing section comprises a generally upstanding inner wall and a radially disposed generally upstanding outer wall, said inner wall and said outer wall in spaced apart relation and forming a channel therebetween.

34. The spring brake actuator of claim 33, wherein said inner wall and said outer wall are interconnected near a lower end of said inner wall and a lower end of said outer wall.

35. The spring brake actuator of claim 33, wherein said second bushing section further comprises a shock absorbing element disposed in said channel.

36. The spring brake actuator of claim 35, wherein said aperture has a first aperture section and a second aperture section, said second aperture section forming a lip extension in said aperture, said first bushing member configured to abut said lip extension.

37. The spring brake actuator of claim 29, wherein said securing means comprises said at least one bushing member configured to cooperatively engage said aperture.

38. The spring brake actuator of claim 37, wherein said aperture has a first aperture section, a second aperture section and a locking groove, said bushing member having a locking element configured to cooperatively engage said locking groove to secure said bushing member in said aperture.

39. The spring brake actuator of claim 38, wherein said locking element comprises one or more engagement tabs on said outer wall.

40. The spring brake actuator of claim 38, wherein said second aperture section forms a lip extension in said aperture, said first bushing member configured to abut said lip extension.

41. The spring brake actuator of claim 38, wherein said bushing member is configured to lockingly engage a lip extension in said aperture.

42. The spring brake actuator of claim 37, wherein said flexing section comprises a generally upstanding inner wall and a radially disposed generally upstanding outer wall, said inner wall and said outer wall in spaced apart relation and forming a channel therebetween.

43. The spring brake actuator of claim 42, wherein said inner wall and said outer wall are interconnected near a lower end of said inner wall and a lower end of said outer wall.

44. The spring brake actuator of claim 37, wherein said flexing section further comprises a shock absorbing element disposed in said channel.

45. A spring brake actuator, comprising:
an adapter base separating a first pressure chamber from a second pressure chamber;
a first housing attached to an upper end of said adapter base to enclose said first chamber;
a second housing attached to a lower end of said adapter base to enclose said second chamber;
a push rod disposed in said first pressure chamber, said push rod configured to extend through an aperture in said adapter base and into said second pressure chamber; and
a bushing assembly disposed in said aperture, said bushing assembly configured to sealably receive said push rod so as to facilitate passage of said push rod through said adapter base while maintaining a fluid tight seal between said first pressure chamber and said second pressure chamber, said bushing assembly having
a cylindrical first bushing member disposed in said aperture, said first bushing member configured to generally allow said push rod to pass therethrough without contacting said aperture;
a cylindrical second bushing member disposed in said aperture, said second bushing member configured with a locking element to cooperatively engage said aperture so as to secure said bushing assembly in said aperture, said second bushing member configured to generally allow flexing movement of said push rod through said aperture; and
a sealing member disposed in said aperture between said first bushing member and said second bushing member, said sealing member configured to sealingly engage said push rod and prevent passage of pressurized fluid between said first pressure chamber and said second pressure chamber.

46. The spring brake actuator of claim 45, wherein said aperture has a first aperture section, a second aperture section and a locking groove, said bushing member having a locking element configured to cooperatively engage said locking groove to secure said bushing member in said aperture.

47. The spring brake actuator of claim 46, wherein said locking element comprises one or more engagement tabs on said outer wall.

48. The spring brake actuator of claim 46, wherein said second aperture section forms a lip extension in said aperture, said first bushing member configured to abut said lip extension.

49. The spring brake actuator of claim 46, wherein said second bushing member comprises a snap-ring element, said snap-ring element configured to engage said locking groove.

50. The spring brake actuator of claim 45, wherein said second bushing section comprises a generally upstanding inner wall and a radially disposed generally upstanding outer wall, said inner wall and said outer wall in spaced apart relation and forming a channel therebetween.

51. The spring brake actuator of claim 50, wherein said inner wall and said outer wall are interconnected near a lower end of said inner wall and a lower end of said outer wall.

52. The spring brake actuator of claim 50, wherein said second bushing section further comprises a shock absorbing element disposed in said channel.

53. The spring brake actuator of claim 45, wherein said locking element is a threaded section on said second bushing member, said threaded section threadably received in said aperture.
